(19) United States
(12) Patent Application Publication
(10) Pub. No.: US 2026/0177572 A1
(43) Pub. Date: Jun. 25, 2026

(54) RACK STORAGE DEVICE, LIQUID CHROMATOGRAPH, LIQUID HANDLER, AND RACK

(71) Applicant: SHIMADZU CORPORATION, Kyoto (JP)

(72) Inventor: Tatsuya OBE, Kyoto (JP)

(73) Assignee: SHIMADZU CORPORATION, Kyoto (JP)

(21) Appl. No.: 19/409,859

(22) Filed: Dec. 5, 2025

(30) Foreign Application Priority Data
Dec. 19, 2024 (JP) 2024-223958

(51) Int. Cl. G01N 35/00; G01N 30/02; G01N 30/88

(52) U.S. Cl. CPC G01N 35/00732; G01N 30/88; G01N 2030/027; G01N 2030/8804; G01N 2035/00752

(57) ABSTRACT

A rack storage device 1 includes a first row rack placement unit RCS1 and a second row rack placement unit RCS2 arranged substantially parallel along a first direction D1, and a sensor 11 movable along a route substantially parallel to the first direction in the vicinity of a boundary between the first row rack placement unit and the second row rack placement unit. The sensor 11 is capable of reading a barcode 23 displayed on each of a plurality of first racks RC1, RC3 arranged in the first row rack placement unit and a barcode 23 displayed on each of a plurality of second racks RC2, RC4 arranged in the second row rack placement unit, and a position of a first barcode 23F in each first rack and a position of a first barcode 23F in each second rack are arranged so as not to overlap with respect to the first direction.

### TECHNICAL FIELD

The present invention relates to a rack storage device capable of storing a plurality of racks, a liquid chromatograph provided with the rack storage device, a liquid handler provided with the rack storage device, and a rack used in the rack storage device.

### BACKGROUND ART

In autosamplers and fraction collectors, racks capable of storing a plurality of sample containers are used. Furthermore, in autosamplers and fraction collectors, a rack storage device capable of storing a plurality of such racks is used.

To improve user convenience, some rack storage devices are equipped with a function for automatically recognizing the presence or absence of a rack and the type of a rack. To realize this function, some rack storage devices are provided with a plurality of sensors corresponding to a plurality of racks. In this type of device, each sensor can recognize a rack by recognizing a barcode displayed on each rack. Alternatively, there are rack storage devices provided with an arm mechanism that allows the sensor to be moved. In this type of device, by controlling the arm to move the sensor, a single sensor recognizes a plurality of racks one by one.

Patent Literature 1 below discloses a rack recognition device that automatically recognizes a rack placed on a rack placement unit. This rack recognition device can recognize the rack by reading the label of the rack with a barcode reader.

### CITATION LIST

### Patent Literature

[Patent Literature 1] Japanese Unexamined Patent Application Publication No. 2007-57332

### SUMMARY OF INVENTION

### Technical Problem

Among the rack storage devices exemplified above, the configuration provided with a plurality of sensors corresponding to a plurality of racks has problems such as an increase in the size of the device configuration related to the sensors or an increase in manufacturing costs. Furthermore, when a user places a rack in the rack storage device, it is necessary to align the orientation of the rack with the plurality of sensors, which makes the rack storage work complicated. In addition, a rack storage device provided with an arm mechanism that allows the sensor to be moved needs to perform an operation of driving the arm to sequentially visit each rack every time a rack is replaced. Therefore, there is a problem that the barcode reading operation takes time.

An object of the present invention is to provide a rack storage device that reduces the user's workload without increasing the device configuration and cost.

### Solution to Problem

A rack storage device according to one aspect of the present invention is a rack storage device capable of placing a plurality of racks for holding a plurality of sample containers, comprising: a rack placement unit having a first row rack placement unit and a second row rack placement unit arranged substantially parallel along a first direction; a reading device movable along a route substantially parallel to the first direction in the vicinity of a boundary between the first row rack placement unit and the second row rack placement unit; and a control unit that controls the reading device, wherein the reading device is capable of reading a barcode displayed on each of a plurality of first racks arranged in the first direction in the first row rack placement unit and a barcode displayed on each of a plurality of second racks arranged in the first direction in the second row rack placement unit, each of the first racks and each of the second racks has a first barcode displayed on one side facing the route with respect to a second direction orthogonal to the first direction, a position of the first barcode in each of the first racks and a position of the first barcode in each of the second racks are arranged so as not to overlap with respect to the first direction, and the control unit, while moving the reading device along the route, sequentially reads the first barcode displayed on each of the plurality of first racks arranged in the first row rack placement unit and the first barcode displayed on each of the plurality of second racks arranged in the second row rack placement unit.

The present invention is also directed to a liquid chromatograph or a liquid handler provided with the above-described rack storage device.

The present invention is also directed to a rack for use in the above-described rack storage device.

### Advantageous Effects of Invention

According to the present invention, it is possible to provide a rack storage device, a liquid chromatograph, a liquid handler, and a rack that reduce the user's workload without increasing the device configuration and cost.

### BRIEF DESCRIPTION OF DRAWINGS

FIG. 1 is a diagram showing a liquid chromatograph according to the present embodiment.

FIG. 2 is a diagram showing a liquid handler according to the present embodiment.

FIG. 3 is a perspective view showing a rack according to the present embodiment.

FIG. 4 is a plan view showing the rack according to the present embodiment.

FIG. 5 is an enlarged plan view of a part of the rack.

FIG. 6 is a plan view of a rack storage device according to the present embodiment.

FIG. 7 is a plan view of the rack storage device in a state where four racks are placed.

FIG. 8 is a side view of the rack storage device shown in FIG. 7 as viewed from the right direction of FIG. 7.

FIG. 9 is a diagram showing an example of a rack placement unit in which three or more racks are arranged in the left-right direction.

FIG. 10 is a diagram showing an example of a rack placement unit in which four rows of racks are arranged in the left-right direction.

### DESCRIPTION OF EMBODIMENTS

Next, a rack storage device, a liquid chromatograph, and a liquid handler according to an embodiment of the present invention will be described with reference to the accompanying drawings.

### (1) Overall Configuration of Liquid Chromatograph

### (1-1) First Usage Form

First, a first usage form of the rack storage device according to the present embodiment will be described. The first usage form is a case where the rack storage device is provided in a fraction collector of a liquid chromatograph.

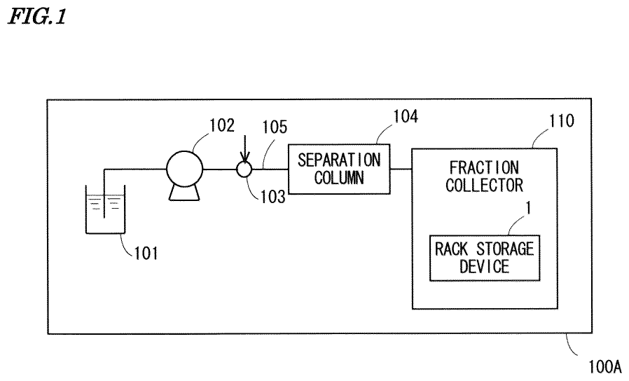

FIG. 1 is an overall view of a liquid chromatograph 100A according to the present embodiment. The liquid chromatograph 100A is configured to include a mobile phase tank 101, a liquid sending pump 102, a sample injection unit 103 (autosampler), a separation column 104, and a fraction collector 110. The fraction collector 110 includes the rack storage device 1 according to the present embodiment.

The liquid sending pump 102 sends a mobile phase stored in the mobile phase tank 101 to an analysis channel 105. The sample injection unit 103 injects a sample into the analysis channel 105 through which the mobile phase flows. The separation column 104 separates the sample flowing through the analysis channel 105 for each component. The component-separated sample flows downstream through the analysis channel 105 together with the mobile phase and is supplied to the fraction collector 110.

The fraction collector 110 fractionates each sample separated in the separation column 104. The fractionated sample is discharged into a sample container held in a rack stored in the rack storage device 1.

### (1-2) Second Usage Form

Next, a second usage form of the rack storage device according to the present embodiment will be described. The second usage form is a case where the rack storage device is provided in a liquid handler attached to a liquid chromatograph.

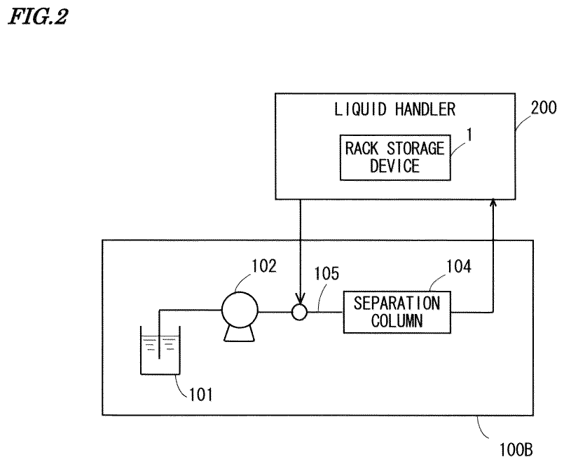

FIG. 2 is an overall view of a liquid chromatograph 100B according to the present embodiment. The liquid chromatograph 100B includes a mobile phase tank 101, a liquid sending pump 102, and a separation column 104. A liquid handler 200 is connected to the liquid chromatograph 100B. The liquid handler 200 includes the rack storage device 1 according to the present embodiment.

The liquid handler 200 has a function as a sample injection unit (autosampler) and a function as a fraction collector. The liquid handler 200 aspirates a sample from a sample container held in a rack stored in the rack storage device 1 using a needle, and injects the aspirated sample into the analysis channel 105. The liquid handler 200 also fractionates each sample separated in the separation column 104. The fractionated sample is discharged into a sample container held in a rack stored in the rack storage device 1.

### (2) Configuration of Rack

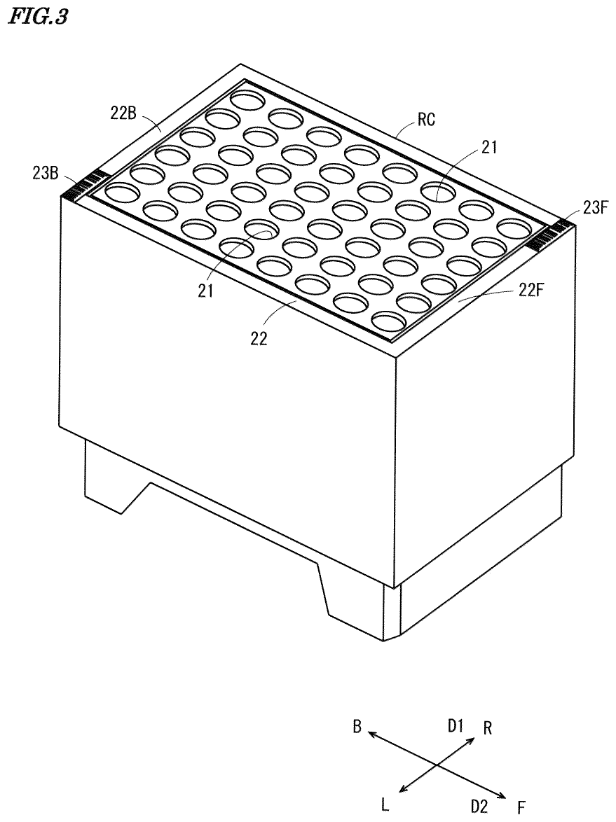

FIG. 3 is a perspective view showing a rack RC according to the present embodiment.

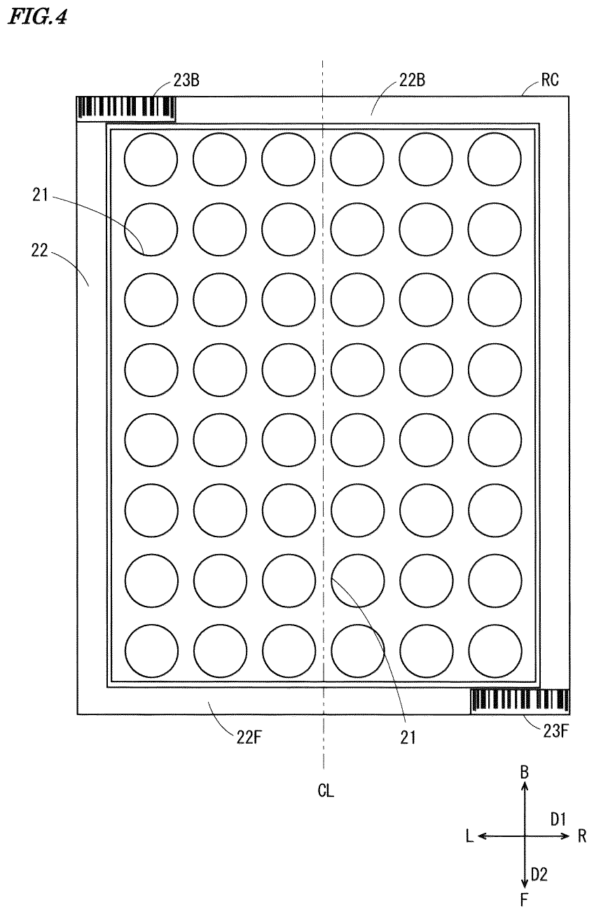

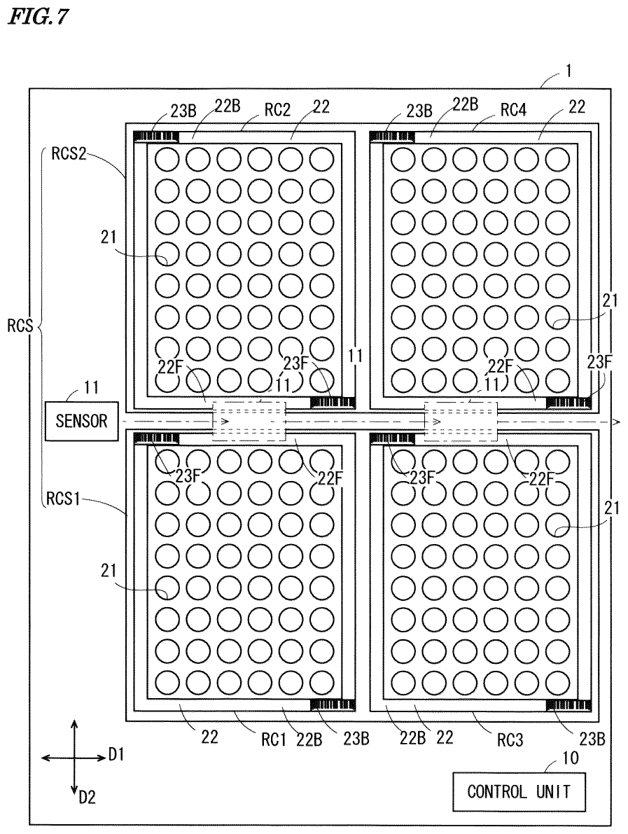

FIG. 4 is a plan view showing the rack RC. The rack storage device 1 shown in FIG. 7, which will be described later, includes four racks RC1 to RC4. The rack RC shown in FIGS. 3 and 4 shows a configuration common to the racks RC1 to RC4. In FIGS. 3 and 4, a forward direction F, a backward direction B, a rightward direction R, and a leftward direction L are defined for each rack RC. The left-right direction is an example of a first direction D1 according to the present invention, and the front-back direction is an example of a second direction D2 according to the present invention.

As shown in FIG. 3, the rack RC includes a plurality of holding parts 21. A sample container is stored in the holding part 21. The sample container is, for example, a vial, a test tube, or the like, and a rack RC corresponding to the sample container appropriately selected according to the type, amount, etc. of the analysis sample is used. In the example shown in FIGS. 3 and 4, the rack RC can store 48 sample containers in a 8 (vertical)× 6 (horizontal) arrangement. In this way, the rack RC can hold a plurality of sample containers.

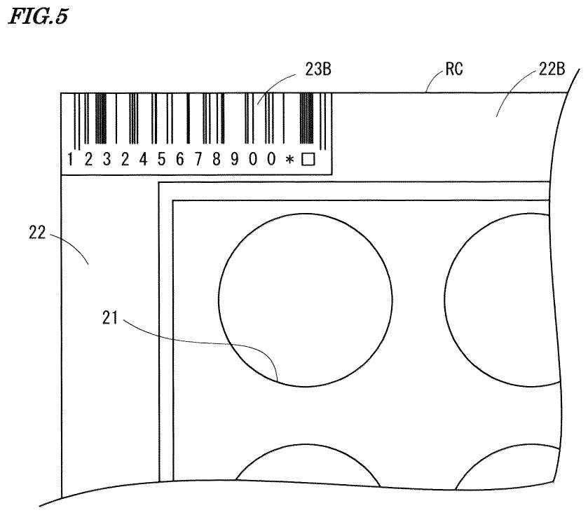

As shown in FIGS. 3 and 4, barcodes 23F and 23B are displayed on an outer peripheral part 22 surrounding the plurality of holding parts 21 of the rack RC. In the following description, for explanations common to the barcodes 23F and 23B, the barcodes 23F and 23B will be collectively referred to as a barcode 23 as appropriate. The barcode 23 may be directly printed on the outer peripheral part 22, or a sticker on which the barcode 23 is printed may be attached to the outer peripheral part 22. FIG. 5 is a partially enlarged view of the rack RC shown in FIG. 4.

In the present embodiment, the barcodes 23 are arranged at two locations on the outer peripheral part 22. As shown in FIG. 4, the two barcodes 23F and 23B are arranged at diagonal positions on the outer peripheral part 22. Specifically, one barcode 23F is arranged on an outer peripheral part 22F located on the front side of the rack RC among the outer peripheral part 22, and the other barcode 23B is arranged on an outer peripheral part 22B located on the rear side of the rack RC among the outer peripheral part 22. More specifically, assuming that the center line of the rack RC is CL, one barcode 23F arranged on the outer peripheral part 22F is arranged on the right side with respect to the center line CL, and the other barcode 23B arranged on the outer peripheral part 22B is arranged on the left side with respect to the center line CL. The barcode 23F is an example of a first barcode according to the present invention, and the barcode 23B is an example of a second barcode according to the present invention.

Information for identifying the rack RC is recorded on both the barcode 23F and the barcode 23B. Therefore, for each rack RC, information for identifying each rack RC is acquired by reading either the barcode 23F or the barcode 23B.

### (3) Configuration of Rack Storage Device

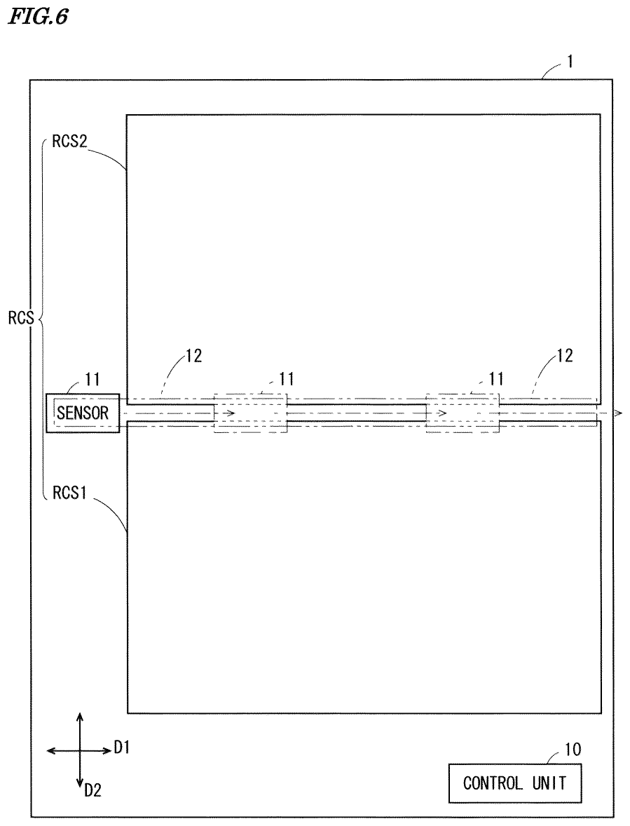

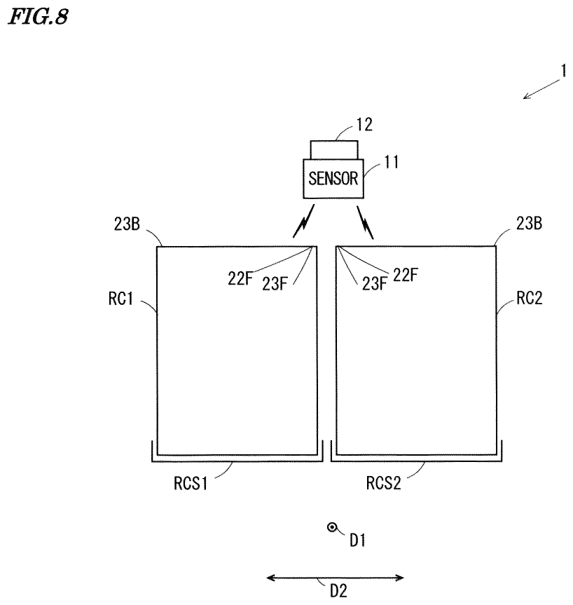

FIG. 6 is a plan view showing the rack storage device 1. FIG. 7 is a plan view of the rack storage device 1 in a state where four racks RC1 to RC4 are placed. FIG. 8 is a side view of the rack storage device 1 shown in FIG. 7 as viewed from the right direction of FIG. 7. In FIGS. 6 to 8, a left-right direction (first direction D1) and a front-back direction (second direction D2) of the rack storage device 1 are defined.

As shown in FIG. 6, the rack storage device 1 of the present embodiment includes a rack placement unit RCS. The rack placement unit RCS is composed of a first row rack placement unit RCS1 and a second row rack placement unit RCS2, both extending in the left-right direction (first direction D1). That is, the first row rack placement unit RCS1 and the second row rack placement unit RCS2 are arranged substantially parallel along the left-right direction (first direction D1). When a rack RC is placed on the rack placement unit RCS, the left-right direction (first direction D1) of the rack RC is aligned with the left-right direction (first direction D1) of the rack placement unit RCS, and the front-back direction (second direction D2) of the rack RC is aligned with the front-back direction (second direction D2) of the rack placement unit RCS.

The rack storage device 1 includes a control unit 10 that controls the rack storage device 1. The control unit 10 is configured to include a CPU (Central Processing Unit), RAM (Random Access Memory), ROM (Read Only Memory), and the like. The control unit 10 controls the operation of the rack storage device 1 by executing a program stored in the ROM on the CPU.

As shown in FIG. 7, in the first row rack placement unit RCS1, a rack RC1 and a rack RC3 are arranged side by side in the left-right direction (first direction D1) from the left. Further, in the second row rack placement unit RCS2, a rack RC2 and a rack RC4 are similarly arranged side by side in the left-right direction (first direction D1) from the left. Then, the rack RC1 and the rack RC2 are arranged side by side in the front-back direction (a second direction D2 orthogonal to the first direction), and the rack RC3 and the rack RC4 are arranged side by side in the front-back direction (a second direction D2 orthogonal to the first direction). The racks RC1 to RC4 have the same configuration as described with reference to FIGS. 3 and 4. The rack RC1 and the rack RC3 are examples of a first rack according to the present invention. The rack RC2 and the rack RC4 are examples of a second rack according to the present invention. However, the number and arrangement of racks RC that can be placed in the rack storage device 1 are not limited to the example of FIG. 6.

As shown in FIG. 7, in the racks RC1 to RC4, a barcode 23F is displayed on the outer peripheral part 22F, and a barcode 23B is displayed on the outer peripheral part 22B. In the example of FIG. 7, the rack RC1 and the rack RC2 are arranged with their respective outer peripheral parts 22F facing each other. Also, in the example of FIG. 7, the rack RC3 and the rack RC4 are arranged with their respective outer peripheral parts 22F facing each other. However, the orientation of the racks RC1 to RC4 in FIG. 7 is merely an example. As a feature of the rack storage device 1 of the present embodiment, the racks RC1 to RC4 may be arranged with the outer peripheral part 22F and the outer peripheral part 22B inverted. That is, it is sufficient that the front-back direction (second direction D2) of the racks RC1 to RC4 is aligned with the front-back direction (second direction D2) of the rack placement unit RCS, and the outer peripheral part 22F and the outer peripheral part 22B may be arranged on either side. That is, the racks RC1 to RC4 can be freely arranged by rotating them 180 degrees in a plane.

As shown in FIG. 6, the rack storage device 1 also includes a sensor 11. The sensor 11 is an example of a reading device according to the present invention. In the present embodiment, the sensor 11 is a one-dimensional barcode reader. The sensor 11 is movable in the left-right direction (first direction D1) on the rack placement unit RCS. As shown in FIG. 6, a rail 12 for guiding the sensor 11 moving in the left-right direction is provided in the vicinity of the boundary between the first row rack placement unit RCS1 and the second row rack placement unit RCS2. The sensor 11 moves in the left-right direction along the rail 12 under the control of the control unit 10. The rail 12 is an example of “a route substantially parallel to the first direction” according to the present invention.

As shown in FIG. 8, in the present embodiment, the rail 12 is located above the racks RC placed in the first row rack placement unit RCS1 and the second row rack placement unit RCS2. Therefore, the sensor 11 moves in the left-right direction above the racks RC placed in the first row rack placement unit RCS1 and the second row rack placement unit RCS2. This allows the sensor 11 to read the barcode 23 arranged on the boundary side (rail 12 side) of the first row rack placement unit RCS1 and the second row rack placement unit RCS2. In the example shown in FIG. 8, the outer peripheral part 22F of the rack RC1 and the outer peripheral part 22F of the rack RC2 are arranged to face each other. In this case, the sensor 11 can sequentially read the barcode 23F displayed on the outer peripheral part 22F of the rack RC1 and the barcode 23F displayed on the outer peripheral part 22F of the rack RC2 by moving in the left-right direction.

Referring to FIG. 7. As shown in FIG. 7, the outer peripheral part 22F of the rack RC1 and the outer peripheral part 22F of the rack RC2 are arranged to face each other, and the outer peripheral part 22F of the rack RC3 and the outer peripheral part 22F of the rack RC4 are arranged to face each other. That is, on one side facing the rail 12 (a route substantially parallel to the first direction), the outer peripheral parts 22F of the racks RC1 to RC4 are arranged. Therefore, in the example of FIG. 7, in the vicinity of the boundary between the first row rack placement unit RCS1 and the second row rack placement unit RCS2, the barcode 23F of the rack RC1→the barcode 23F of the rack RC2→the barcode 23F of the rack RC3→the barcode 23F of the rack RC4 are arranged in this order from the left. Then, the four barcodes 23F are arranged at positions that do not overlap with respect to the first direction. In other words, the four barcodes 23F are arranged so as not to overlap when viewed from the second direction. This allows the four barcodes 23F to be read by a single scan in which the sensor 11 is moved once in the rightward direction under the control of the control unit 10. Of course, the reading operation may be performed by moving the sensor 11 once from the left side to the right side.

In the example shown in FIG. 7, the outer peripheral parts 22F of the racks RC1 to RC4 are arranged on one side facing the rail 12 (a route substantially parallel to the first direction). As described above, in the rack storage device 1 of the present embodiment, the user can freely change the orientation of the racks RC1 to RC4 in the front-back direction. That is, the outer peripheral parts 22B of the racks RC1 to RC4 may be arranged on one side facing the rail 12 (a route substantially parallel to the first direction). As described above, the barcode 23F and the barcode 23B of each rack RC are displayed at diagonal positions on the outer peripheral part 22 of each rack RC. And, information for identifying each rack RC is recorded on both the barcode 23F and the barcode 23B. Therefore, even if any one or more of the racks RC1 to RC4 are rotated 180 degrees in a plane from the state of FIG. 7, the arrangement of the barcodes 23 is the same. Therefore, even if the orientation of each rack RC in the front-back direction is arbitrarily changed, the four barcodes 23 can be read by a single reading operation (a single scan) using the sensor 11.

Since the rack storage device 1 of the present embodiment is configured as described above, it is possible to sequentially read all the barcodes 23 in a single scan by one sensor 11. This makes it possible to reduce the size of the device configuration related to the barcode reading device, and to suppress the manufacturing cost. Furthermore, when the user places the rack RC in the rack storage device 1, there is no problem even if the orientation in the front-back direction is changed. This can reduce the user's preparation workload.

### (4) Other Embodiments

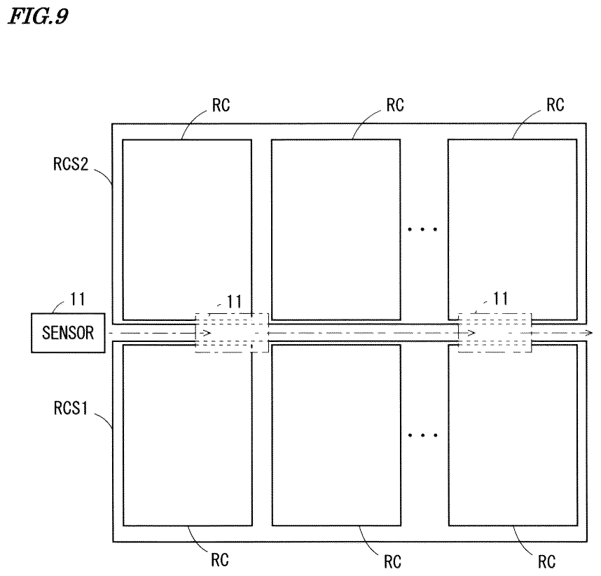

In the above embodiment, the first row rack placement unit RCS1 and the second row rack placement unit RCS2 are configured to be able to arrange two racks RC in the left-right direction, but as shown in FIG. 9, the first row rack placement unit RCS1 and the second row rack placement unit RCS2 may have a configuration capable of placing three or more racks RC in the left-right direction.

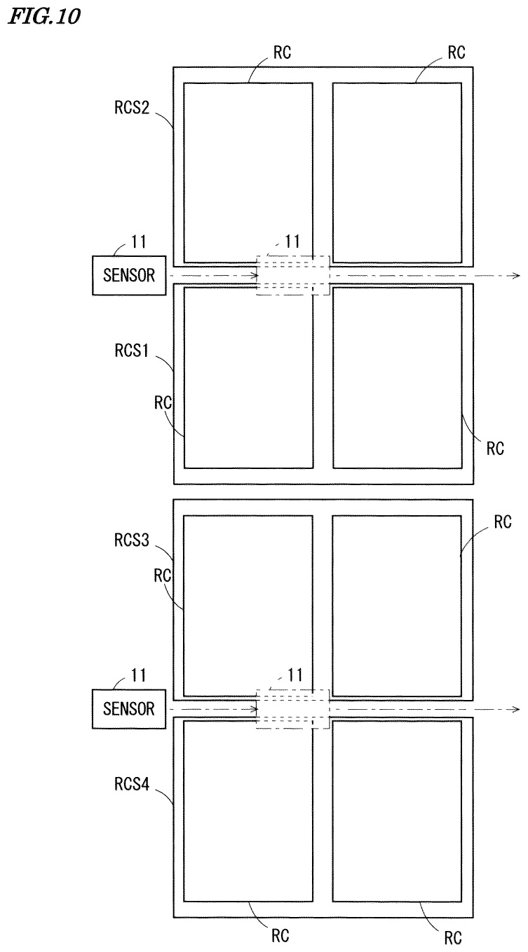

In the above embodiment, the rack placement unit RCS has a configuration in which the racks RC are arranged in two rows by the first row rack placement unit RCS1 and the second row rack placement unit RCS2, but this is merely an example. For example, as shown in FIG. 10, the rack placement unit RCS may have a configuration in which the racks RC are arranged in four rows. In FIG. 10, a first row rack placement unit RCS1, a second row rack placement unit RCS2, a third row rack placement unit RCS3, and a fourth row rack placement unit RCS4 are arranged substantially in parallel. In this case, by configuring the sensor to be movable in the vicinity of the boundary of the racks for every two rows, it is possible to sequentially recognize all the racks RC in a single scan performed simultaneously. That is, it is possible to adopt a configuration in which one sensor reads the barcodes of the racks RC placed in the first row rack placement unit RCS1 and the second row rack placement unit RCS2, and the other sensor reads the barcodes of the racks RC placed in the third row rack placement unit RCS3 and the fourth row rack placement unit RCS4.

In the above embodiment, a one-dimensional barcode is used as the barcode, but this is merely an example. In the rack storage device 1 of the present embodiment, a two-dimensional barcode may be used as the barcode. When a two-dimensional barcode is used as the barcode, an image capturing device is used as a reading device instead of the sensor 11 in the above embodiment. With the same configuration as above, by moving the image capturing device along the rail 12, it is possible to recognize the rack RC by sequentially capturing images of the two-dimensional barcodes.

In the above embodiment, the sensor 11 is guided and moved by the rail 12 under the control of the control unit 10. As another configuration, the sensor 11 may be supported by an arm, and the sensor 11 may be moved by driving the arm. By using, for example, an articulated robot as the arm, it is possible to configure the sensor 11 to move along a route near the boundary between the first row rack placement unit RCS1 and the second row rack placement unit RCS2.

### (5) Aspects

Those skilled in the art will understand that the plurality of exemplary embodiments described above are specific examples of the following aspects.

### (Item 1)

A rack storage device according to one aspect of the present invention is a rack storage device capable of placing a plurality of racks for holding a plurality of sample containers, comprising:
a rack placement unit having a first row rack placement unit and a second row rack placement unit arranged substantially parallel along a first direction;
a reading device movable along a route substantially parallel to the first direction in the vicinity of a boundary between the first row rack placement unit and the second row rack placement unit; and
a control unit that controls the reading device, wherein
the reading device is capable of reading a barcode displayed on each of a plurality of first racks arranged in the first direction in the first row rack placement unit and a barcode displayed on each of a plurality of second racks arranged in the first direction in the second row rack placement unit,
each of the first racks and each of the second racks has a first barcode displayed on one side facing the route with respect to a second direction orthogonal to the first direction, a position of the first barcode in each of the first racks and a position of the first barcode in each of the second racks are arranged so as not to overlap with respect to the first direction, and
the control unit, while moving the reading device along the route, sequentially reads the first barcode displayed on each of the plurality of first racks arranged in the first row rack placement unit and the first barcode displayed on each of the plurality of second racks arranged in the second row rack placement unit.

Since the rack storage device is configured as described above, it is possible to reduce the size of the device configuration related to the barcode reading device, and to suppress the manufacturing cost.

### (Item 2)

In the rack storage device according to Item 1,
each of the first racks and each of the second racks has a second barcode displayed on the other side opposite to the route with respect to the second direction,
when each of the first racks and each of the second racks is rotated by 180 degrees in a plane, a position of the second barcode substantially coincides with a position of the first barcode, and
information for identifying each first rack is recorded on both the first barcode and the second barcode displayed on each first rack, and information for identifying each second rack is recorded on both the first barcode and the second barcode displayed on each second rack.

When the user places a rack in the rack storage device, there is no problem even if the orientation of the rack is changed with respect to the second direction. This can reduce the user's preparation workload.

### (Item 3)

In the rack storage device according to Item 1,
the first barcode and the second barcode include a one-dimensional barcode, and
the reading device may include a sensor capable of reading the one-dimensional barcode.

It is possible to recognize the rack by reading the one-dimensional barcode.

### (Item 4)

In the rack storage device according to Item 1,
the first barcode and the second barcode include a two-dimensional barcode, and
the reading device may include an imaging device that captures the two-dimensional barcode.

It is possible to recognize the rack by reading the two-dimensional barcode.

### (Item 5)

In the rack storage device according to Item 1,
the control unit may read the first barcode displayed on each of the plurality of first racks and the first barcode displayed on each of the plurality of second racks in a single scan by moving the reading device on the route.

It is possible to sequentially read all the barcodes in a single scan by the reading device, and the rack recognition time can be shortened.

### (Item 6)

In the rack storage device according to Item 2,
the control unit may read the first barcode or the second barcode displayed on each of the plurality of first racks and the first barcode or the second barcode displayed on each of the plurality of second racks in a single scan by moving the reading device on the route.

It is possible to sequentially read all the barcodes in a single scan by the reading device, and the rack recognition time can be shortened. Also, it is possible to read the barcode even if the orientation of the rack is reversed with respect to the second direction.

### (Item 7)

In the rack storage device according to Item 1,
the reading device may move while being guided by a rail arranged along the route.

The barcodes can be sequentially read by the reading device moving on the rail.

### (Item 8)

The rack storage device according to Item 1, further comprising:
an arm that supports the reading device, wherein the control unit may move the reading device along the route by controlling the arm.

The barcodes can be sequentially read by the reading device moving under the control of the arm.

### (Item 9)

A liquid chromatograph according to another aspect of the present invention comprises:
the rack storage device according to any one of Items 1 to 8.

The overall configuration of the liquid chromatograph provided with the rack storage device can be made smaller. Also, the device cost can be suppressed.

### (Item 10)

A liquid handler according to another aspect of the present invention comprises:
the rack storage device according to any one of Items 1 to 8.

The overall configuration of the liquid handler provided with the rack storage device can be made smaller. Also, the device cost can be suppressed.

### (Item 11)

A rack according to another aspect of the present invention is:
used in the rack storage device according to any one of Items 1 to 8.

Since the barcode can be read even if the orientation of the rack is changed with respect to the second direction, the user's preparation workload is reduced.

### REFERENCE SIGNS LIST

1: Rack storage device
11: Sensor
12: Rail
21: Holding part
22, 22F, 22B: Outer peripheral part
23, 23B, 23F: Barcode
CL: Center line
D1: First direction
D2: Second direction
RC, RC1, RC2, RC3, RC4: Rack
RCS: Rack placement unit
RCS1: First row rack placement unit
RCS2: Second row rack placement unit

1. A rack storage device capable of placing a plurality of racks for holding a plurality of sample containers, the rack storage device comprising:
a rack placement unit having a first row rack placement unit and a second row rack placement unit arranged substantially parallel along a first direction;
a reading device movable along a route substantially parallel to the first direction in the vicinity of a boundary between the first row rack placement unit and the second row rack placement unit; and
a control unit that controls the reading device, wherein
the reading device is capable of reading a barcode displayed on each of a plurality of first racks arranged in the first direction in the first row rack placement unit and a barcode displayed on each of a plurality of second racks arranged in the first direction in the second row rack placement unit,
each of the first racks and each of the second racks has a first barcode displayed on one side facing the route with respect to a second direction orthogonal to the first direction, a position of the first barcode in each of the first racks and a position of the first barcode in each of the second racks are arranged so as not to overlap with respect to the first direction, and
the control unit, while moving the reading device along the route, sequentially reads the first barcode displayed on each of the plurality of first racks arranged in the first row rack placement unit and the first barcode displayed on each of the plurality of second racks arranged in the second row rack placement unit.

2. The rack storage device according to claim 1, wherein
each of the first racks and each of the second racks has a second barcode displayed on the other side opposite to the route with respect to the second direction,
when each of the first racks and each of the second racks is rotated by 180 degrees in a plane, a position of the second barcode substantially coincides with a position of the first barcode, and
information for identifying each first rack is recorded on both the first barcode and the second barcode displayed on each first rack, and information for identifying each second rack is recorded on both the first barcode and the second barcode displayed on each second rack.

3. The rack storage device according to claim 1, wherein
the first barcode and the second barcode include a one-dimensional barcode, and
the reading device includes a sensor capable of reading the one-dimensional barcode.

4. The rack storage device according to claim 1, wherein
the first barcode and the second barcode include a two-dimensional barcode, and
the reading device includes an imaging device that captures the two-dimensional barcode.

5. The rack storage device according to claim 1, wherein
the control unit reads the first barcode displayed on each of the plurality of first racks and the first barcode displayed on each of the plurality of second racks in a single scan by moving the reading device on the route.

6. The rack storage device according to claim 2, wherein
the control unit reads the first barcode or the second barcode displayed on each of the plurality of first racks and the first barcode or the second barcode displayed on each of the plurality of second racks in a single scan by moving the reading device on the route.

7. The rack storage device according to claim 1, wherein
the reading device moves while being guided by a rail arranged along the route.

8. The rack storage device according to claim 1, further comprising:
an arm that supports the reading device,
wherein the control unit moves the reading device along the route by controlling the arm.

9. A liquid chromatograph comprising the rack storage device according to claim 1.

10. A liquid handler comprising the rack storage device according to claim 1.

11. A rack for use in the rack storage device according to claim 1.
